(19) United States
(12) Patent Application Publication
(10) Pub. No.: US 2022/0230771 A1
(43) Pub. Date: Jul. 21, 2022

(54) METHOD FOR TREATING WASTE MATERIAL

(71) Applicant: TEKNOLOGIAN TUTKIMUSKESKUS VTT OY, Espoo (FI)

(72) Inventors: Tapio VEHMAS, Espoo (FI); Markku LEIVO, Espoo (FI); Matti NIEMINEN, Espoo (FI); Jaana LAATIKAINEN-LUNTAMA, Espoo (FI); Markus OLIN, Espoo (FI)

(21) Appl. No.: 17/609,079

(22) PCT Filed: May 6, 2020
(86) PCT No.: PCT/FI2020/050304

§ 371 Date: Nov. 5, 2021

(30) Foreign Application Priority Data
May 6, 2019 (FI) 20195369

(51) Int. Cl. G21F 9/30; C04B 28/00; C04B 18/04

(52) U.S. Cl. CPC G21F 9/304; C04B 2111/00767; C04B 18/0463; C04B 28/006

(57) ABSTRACT

The present invention relates to a method for treating waste material comprising organic components and low and/or medium level radioactive agents. The method comprises encapsulating the waste material into a matrix, gasifying the waste material at a temperature between 600 and 950° C. to form a gaseous fraction and a solid fraction comprising low and/or medium level radioactive agents and combustion residues of the organic components and encapsulating the solid fraction by a geopolymer matrix comprising metakaolin.

### FIELD OF THE INVENTION

The present invention relates to a method for treating waste material comprising organic components and low and/or medium level radioactive agents. The method comprises encapsulating the waste material into a matrix.

### BACKGROUND OF THE INVENTION

Waste material comprising organic components and low and/or medium level radioactive agents are usually encapsulated into a matrix inside a steel container. Nowadays the major part of the matrix is usually Portland cement. After the radioactive agents are encapsulated the containers are stored in the bed rock.

One of the disadvantages associated with the above method is that the major part of the encapsulation comprises the matrix. Typically, only about 10 wt-% of the total mass of the encapsulation is waste material, i.e. the loading factor is about 10%. The loading factor may be restricted by the solubility of the radionuclides from the matrix, or the mechanical properties of the matrix.

It is possible to replace cement by a geopolymer. As the waste material comprises low and/or medium level radioactive agents, it is crucial that the matrix has a good retention capability, i.e. it can bind radionuclides into the matrix. Cesium, which is the most significant radionuclide, has a solubility of 80 to 100 g/l in the matrix of Portland cement and a solubility of about 2 g/l in the matrix of at least one geopolymer. The far better insolubility in the matrix of at least one geopolymer cannot be utilized due to restrictions in mechanical properties of the geopolymers. Thus, the loading factor cannot be increased although the geopolymers possess better capability to bind ion-exchange resins. The loading factor refers to the ratio of the resins to the total weight of the encapsulation as percentages, i.e. loading factor=(m(resins)/m(tot))*100%.

### BRIEF DESCRIPTION OF THE INVENTION

An object of the present invention to provide a method for implementing the method so as to solve the above problems. The objects of the invention are achieved by a method which is characterized by what is stated in the independent claim. The preferred embodiments of the invention are disclosed in the dependent claims.

The invention is based on the idea of decreasing the volume of the waste material comprising organic components and low and/or medium level radioactive agents to be encapsulated. An advantage of the method of the invention is that the loading factor can be increased remarkably and thus, less storage space is required in the bed rock. Further, the process is cost effective and easy to use in different scales.

The method of the invention comprises two main steps: First step for reducing the volume of the waste material and second step for encapsulating the waste material, i.e. a solid fraction, whose volume has been reduced. The volume of the waste material may even be reduced over 90 wt.-% in the first process step.

The untreated waste material includes organic components and radioactive agents. The waste may contain ion-exchange resins and operational waste from nuclear power plants.

In the first step, the waste material including organic components and radioactive agents, which are low level and/or medium level radioactive agents, is gasified at temperature between 600-950° C. in a reactor to form a gaseous material and a solid fraction. The gaseous material is cooled by water quenching so that temperature is between 300-500° C. after the cooling. A solid fraction including radioactive agents is removed from the gaseous material in a gas cleaning step.

The first step produces a product gas. The product gas contains treated gaseous material which has been formed from waste material including organic components and radioactive agents which are low level and/or medium level radioactive agents so that the waste material including organic components and radioactive agents has been gasified at temperature between 600-950° C. in a reactor to form a gaseous material, the gaseous material has been cooled by water quenching so that temperature is between 300-500° C. after the cooling, and solid fraction including radioactive agents has been removed from the gaseous material in a gas cleaning step in an apparatus comprising a gas cleaning device. The gaseous material is preferably combustible.

In this context, the radioactive agents refer to any radioactive material, compounds and chemical elements and their derivates. In this context, radioactive agents are low level and/or medium level.

In this context, the waste material including organic components and radioactive agents means any material which includes organic and radioactive components. The waste material including organic components and radioactive agents may be selected from the group containing resins, such as resins from nuclear power plant, clothes, such as industrial protective clothing and protective clothing, contaminated wood, contaminated vegetable matter such as corn, straw and hay.

Any reactor known per se can be used in the gasification. Preferably, the reactor can be a fluidized bed reactor, bubbling or circulating fluidized bed reactor or the like. Sand, aluminum oxide or other suitable bed material may be used as the bed material.

Radioactive agents and other metals may partly vaporize during the gasification. When the gaseous material is cooled so the radioactive agents and other metals which have vaporized during the gasification are condensed and changed back to a solid form.

The waste material including organic components and radioactive agents is gasified at temperature between 600-900° C. in a reactor to form a gaseous material. The waste material may be gasified at temperature between 700−950° C., 700-900° C., 50-950° C. or 750-900° C. depending on variations of the method.

In one variation, the waste material including organic components and radioactive agents is gasified by air. In a preferred variation air ratio is below 1, preferably below 0.7, more preferable below 0.5 and most preferable below 0.4.

In one variation, the waste material including organic components and radioactive agents may be dewatered before the gasification. In one variation water is removed mechanically from the waste material including organic components and radioactive agents. In one variation the waste material including organis components and radioactive agents is dried by a drying device.

In one variation another organic material is added into the waste material including organic components and radioactive agents before the gasification. The other organic material may be selected from the group containing oil, plastic, polymers or the like. It is important that ash content of the other organic material is low.

In one variation, the gaseous material is cooled so that temperature is between 350-450° C. after the cooling. Preferably, the gaseous material is cooled by water quenching. The apparatus comprises water quenching step for cooling the gaseous material. The water quenching step may include one or more devices suitable for carrying out water quenching.

In one variation, the gaseous material is cooled by heat exchanger. The apparatus may comprise at least one heat exchanger for cooling the gaseous material.

The gaseous material is filtered in the gas cleaning step in order to remove a solid fraction including radioactive agents. The apparatus comprises at least one filtration device. In one variation, the filtration is carried out at temperatures between 300-500° C. It is important that the temperature is not too high because, for example, at temperature 600° C. metals may traverse the filtration device. The filtration device may be a hot gas filter. In one variation the filtration device includes at least one or more ceramic filter/filters. In one variation the filtration device includes at least one or more metal filter, preferably sintered metal filter.

In one variation, the treated gaseous material is burn after the removing of the solid fraction including radioactive agents. Preferably, the treated gaseous material is burn at temperature over 1000° C. In one variation, the apparatus comprises a combustion reactor in which the treated gaseous material is burn after the removing of the solid fraction including radioactive agents.

In one variation, the treated gaseous material or the gas flow of the combustion is post treated by a gas scrubbing. Preferably, sulphur is removed during the gas scrubbing. In one variation, the treated gaseous material may be post treated by the gas scrubbing directly after the removing of the solid fraction including radioactive agents or alternatively the gas flow may be post treated by the gas scrubbing after the combustion step which has been done after the removing of the solid fraction including radioactive agents. In one variation, the apparatus comprises a gas scrubbing device for post-treating.

In one variation, sulphur may be removed in connection with the combustion step of the treated gaseous material. However, the sulphur removing is easier to carry out in connection with the gas scrubbing.

In one variation, the product gas contains 70-100 vol-% treated gaseous material.

In one variation, the product gas or the treated gaseous material is used and utilized as a fuel of energy production process. In one variation, the product gas or the treated gaseous material is used as a fuel as such or after the gas scrubbing.

In the second step, the combustion residues of the organic components, i.e. the solid fraction, is encapsulated by a geopolymer matrix comprising metakaolin. Metakaolin is the anhydrous calcined form of kaolinite. Kaolinite occurs in mineral kaolin.

The solid fraction is mixed with metakaolin and aqueous solution of sodium silicate and potassium hydroxide is added to the mixture. Instead of sodium silicate may be used potassium silicate. Also a mixture of the above mentioned silicates is possible. Instead of potassium hydroxide may be used any other hydroxide, e.g. sodium hydroxide, or mixtures of different hydroxides. The mixture is agitated until a homogenous paste is achieved. The homogenous paste may be heated in humid or autogeneous conditions in order to initiate a polysialate polymerization process. The paste hardens also at room temperature so the heating step is optional. The polymerization process hardens the homogenous paste to a solid blank. After the solid blank has adequate mechanical properties it may be heated in order to remove water through evaporation. As the previous heating step, also this heating step is optional. As a result of the above mentioned process a finished product to be stored in the bed rock has been formed. The finished product may have a loading factor from 75% to above 100%.

### DETAILED DESCRIPTION OF THE INVENTION

### Example

Radioactive ion exchange resins are treated with a gasification technique in a temperature of 850° C., i.e. they are treated according to the first method step of the invention. A solid fraction having a reduced volume is obtained from the first method step. The solid fraction resembles at this stage fine ash.

The gasified solid fraction is mixed with metakaolin (e.g. Metamax, BASF). Aqueous solution of sodium silicate (NaSiO, e.g. Zeopol 33, Huber Engineered Materials) and potassium hydroxide (KOH) is added to the mixture. The mixture is agitated until a homogenous paste is achieved. Mixing can be performed with known mixing devices usually used in connection with encapsulation processes.

After the solid blank has adequate mechanical properties, it may heated. Thus a finished product to be stored in the bed rock has been formed. The finished product has a loading factor from 75% to above 100%.

It will be obvious to a person skilled in the art that, as the technology advances, the inventive concept can be implemented in various ways. The invention and its embodiments are not limited to the examples described above but may vary within the scope of the claims.

1. A method for treating waste material comprising organic components and low and/or medium level radioactive agents, the method comprises encapsulating the waste material into a matrix, wherein the method comprises
gasifying the waste material at a temperature between 600 and 950° C. to form a gaseous fraction and a solid fraction comprising low and/or medium level radioactive agents and combustion residues of the organic components and
encapsulating the solid fraction by a geopolymer matrix comprising metakaolin.

2. The method according to claim 1, wherein the method comprises mixing the solid fraction with metakaolin.

3. The method according to claim 2, wherein the method comprises adding aqueous solution of a silicate or a mixture of silicates and a hydroxide or a mixture of hydroxides to the mixture of the solid fraction and metakaolin.

4. The method according to claim 3, wherein the method comprises adding a sodium silicate or a potassium silicate or both.

5. The method according to claim 3, wherein the method comprises adding sodium hydroxide or potassium hydroxide or both.

6. The method according to claim 3, wherein the method comprises agitating the mixture until a homogenous paste is achieved.

7. The method according to claim 6, whereinwherein the method comprises heating the homogenous paste in humid or autogeneous conditions in order to initiate a polysialate polymerization process.

8. The method according to claim 6, wherein the method comprises settling the homogenous paste at room temperature.

9. The method according to claim 7, wherein the method comprises heating in order to remove water.
